(19) United States
(12) Patent Application Publication
(10) Pub. No.: US 2008/0223209 A1
(43) Pub. Date: Sep. 18, 2008

(54) SYRINGE BARREL WIPER FOR LIQUID DISPENSING

(75) Inventor: Harry F. Slater, Grass Valley, CA (US)

Correspondence Address: JOHN P. O'BANION;O'BANION & RITCHEY LLP, 400 CAPITOL MALL SUITE 1550, SACRAMENTO, CA, 95814, US

(73) Assignee: TRICONTINENT SCIENTIFIC, GRASS VALLEY, CA (US)

(21) Appl. No.: 12/048,916

(22) Filed: Mar. 14, 2008

Related U.S. Application Data
(60) Provisional application No. 60/895,352, filed on Mar. 16, 2007.

(51) Int. Cl. G01F 11/00; F01B 31/00

(52) U.S. Cl. 92/158; 222/342

(57) ABSTRACT

A syringe for syringe pumps or like instruments is disclosed, having a modified plunger disposed with a barrel wiper for enhancing seal life of the syringe. The syringe comprises a cylindrical barrel that is slideably engaged to a plunger via a seal. The syringe barrel wiper provides for enhanced seal life by extended controlled lubrication to inhibit debris adherence and reduced seal friction by wiping the inside of the barrel to remove debris buildup and egress of debris. The wiper comprises a lubricant-permeated porous polymer material shaped as a cylindrical tubular member.

### CROSS-REFERENCE TO RELATED APPLICATIONS

This application claims priority from U.S. provisional application Ser. No. 60/895,352 filed on Mar. 16, 2007, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to liquid dispensing, and more particularly to liquid dispensing pumps with glass barrel syringes.

2. Description of Related Art

The need for more precise delivery mechanisms for fluid dispensing systems such as analytical chemistry techniques is increasing. Syringe or infusion pumps are electrically driven devices that deliver a constant, often very small, volume of solution over a prolonged period of time for a variety of applications, including the delivery of liquid reagents.

Many liquid dispensing pumps include glass-barrel syringes that have sliding seals, which with continued operation tend to increase in seal friction and wear. After a relatively short period of operation, seal friction and wear in common devices increase to a degree that causes unacceptable performance in the form of excessive friction, leaking, or both.

A number of seals have been devised to increase the useful period of operation of these syringes. Most use a seal geometry that accommodates the properties of the seal material to yield an effective sealing lip, or multiple sealing lips, that bear against the inner wall of the syringe barrel. Seals can be separate members that mount to a syringe plunger or can be integral to the plunger. Some seals include a scraper that is either integral to the seal or a separate member that bears against the inside wall of the syringe barrel, which scrapes off some of the otherwise inherent buildup of debris that contributes to seal friction and wear.

However, typical current-day seals, with and without scrapers, generally fall short of achieving a desirable seal life, particularly when used for dispensing liquids containing additives that are prone to forming films and crystals when the carrier for the additives evaporates. For example, water is commonly used as a carrier for reagents and buffers, and evaporation of the water tends to leave debris in the form of films and crystals that adhere to the inner wall of the syringe barrel. This debris is abrasive to the seal and causes failure after repeated contact.

Carrier evaporation, and subsequent formation of films and crystals is inherent to the seal sliding on the wall of the syringe barrel. During operation, at some point and essentially continuously at the molecular level, a minute quantity of liquid leaks past the seal that separates the liquid filled section of the syringe barrel from the essentially dry section that is exposed to the open environment. Over time the escaping liquid evaporates, leaving adhered to the wall of the syringe barrel an increasing film thickness and quantity of crystals that are abrasive and damaging to the seals.

Accordingly, an object of the present invention is to provide a syringe assembly that continuously lubricates the inner surface of the syringe barrel to maintain seal life. Another object of the present invention is to provide a syringe assembly that continuously cleans the inner surface of the syringe barrel.

At least some of these objectives will be met in the following disclosure.

### BRIEF SUMMARY OF THE INVENTION

A syringe barrel and wiper is disclosed for providing enhanced seal life of a plunger for a piston pump commonly used as a syringe pump. The syringe pump comprises a cylindrical barrel that is slideably engaged to a plunger via a seal. The syringe barrel wiper provides for enhanced seal life for extended controlled lubrication to inhibit debris adherence and reduce seal friction by wiping the inside of the barrel to remove debris buildup and egress of debris. The wiper comprises a lubricant-permeated porous polymer material shaped as a cylindrical tubular member.

An aspect of the invention is a syringe for dispensing fluids. The syringe includes a cylindrical barrel having a distal end and a proximal end, with the barrel having a chamber emanating at an opening at the proximal end and terminating near the distal end. A plunger configured to reciprocate axially inside the chamber, with the plunger comprising a distal end having a seal, and a proximal end comprising an arm terminating at a location outside the chamber. The seal is configured to slideably engage an inside wall of the chamber. A wiper is disposed on the plunger proximal to the seal and is configured to hold a volume of lubricant and engage the inner surface of the chamber so that the lubricant is disposed on the inner surface as the plunger reciprocates in the chamber.

Preferably, the wiper comprises a porous polymer permeated with the volume of lubricant. The wiper generally has a cylindrical outer surface that forms an interference fit with the inner surface of the chamber when installed in the chamber.

In a preferred embodiment, the wiper is slideably disposed on the plunger so that a gap is formed between the distal end of the wiper and the proximal end of the seal as the plunger travels distally in the chamber. The gap is configured to collect debris from the inner surface of the chamber.

The wiper preferably has a central channel configured to be disposed over a step-reduced section extending a specified length between the proximal end of the seal and the arm of the plunger. The wiper is shaped or sized so that a recess is formed between the wiper and the step-reduced section to facilitate migration of the debris proximally along said plunger.

In another preferred embodiment, the length of the step-reduced section is longer than the length of the wiper so that distal reciprocation of the plunger in the chamber causes the wiper to slide axially to the plunger arm at the proximal end of the step-reduced section to form the gap at the distal end. Also, proximal reciprocation of the plunger in the chamber causes the wiper to slide axially to the seal at the distal end of the step-reduced section to form a gap between the proximal end of the wiper and the plunger arm to facilitate egress of the collected debris out of the chamber.

In one embodiment, the wiper is tubular having an inner diameter defining the central channel, wherein the step reduced section comprises a diameter that is smaller than the inner diameter of the wiper to create the recess.

The wiper may have a slit running axially down the length of the wiper to allow the wiper to be installed on the step-reduced section.

Another aspect is a syringe assembly for dispensing fluids. The syringe assembly includes a cylindrical barrel having a distal end and a proximal end and a chamber emanating at an opening at the proximal end and terminating near the distal end. A plunger is configured to reciprocate axially inside the chamber. The plunger includes a distal end having a seal configured to slideably engage an inside wall of the chamber, a proximal end comprising an arm extending to a location outside the chamber, and a neck disposed between the seal and the arm. The neck has a smaller cross-section than the arm and the seal. A wiper is disposed on the plunger proximal to the seal over the neck via a central channel in the wiper, wherein the central channel of the wiper is shaped to form a recess between the wiper and the neck. The wiper has an outer diameter configured to engage the inner wall of the chamber to scrape debris from the wall which may then migrate through the recess to a location outside the chamber.

In one embodiment, the wiper has a length that is smaller than the length of the neck and the wiper is slideably disposed on the neck of the plunger such that, the proximal end of the wiper abuts against the arm of the plunger when the plunger is travelling toward the distal end of the chamber. A gap is formed between the distal end of the wiper and the seal, wherein the gap allows fluid communication from the inner wall of the chamber to the recess between the wiper and the neck. The distal end of the wiper abuts against the seal when the plunger is travelling toward the proximal end of the chamber to form a gap between the proximal end of the wiper and the arm, wherein the gap between the proximal end of the wiper and the arm allows debris egress from the recess to a location external to the chamber.

In one embodiment, the central channel of the wiper has a diameter that is larger than the diameter of the neck to form an annular recess between the wiper and the neck. Alternatively, or in combination, the central channel of the wiper comprises a groove to facilitate migration of debris proximally out of the chamber.

Another aspect is a syringe pump assembly comprising a cylindrical barrel having a distal end and a proximal end and a chamber emanating at an opening at the proximal end and terminating near the distal end with a valve in fluid communication with the distal end of the chamber. A plunger is configured to reciprocate axially inside the chamber. The plunger has a distal end having a seal configured to slideably engage an inside wall of the chamber, a proximal end comprising an arm extending to a location outside the chamber, and a neck disposed between the seal and the arm. A wiper is disposed on the plunger proximal to the seal over the neck via a central channel in the wiper. A reciprocating arm is coupled to the proximal end of the plunger arm and a motor for driving motion of the plunger inside the chamber. The wiper holds a volume of lubricant and is sized to engage the inner surface of the chamber so that the lubricant is disposed on the inner surface as the plunger reciprocates in the chamber.

In one embodiment, the wiper has a length that is smaller than the length of the neck, wherein the wiper is slideably disposed on the neck of the plunger such that the proximal end of the wiper abuts against the arm of the plunger when the plunger is travelling toward the distal end of the chamber to dispense fluid out of said chamber and through said valve. A gap is formed between the distal end of the wiper and the seal, the gap allowing fluid communication from the inner wall of the chamber to the recess between the wiper and the neck. Correspondingly, the distal end of the wiper abuts against the seal when the plunger is travelling toward the proximal end of the chamber to aspirate fluid through the valve into the chamber, with the wiper forming a gap between the proximal end of the wiper and the arm to allow debris egress from the recess to a location external to the chamber.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates a perspective view of the syringe of the present invention installed in a syringe pump.

FIG. 2 illustrates an exploded view of the syringe assembly of the present invention.

FIG. 3 is a plan view of the syringe wiper of present invention.

FIG. 4 is a side view of the syringe wiper shown in FIG. 3.

FIG. 5 is a perspective view of the syringe wiper shown in FIG. 3.

FIG. 6 is a cross-sectional view of an assembled syringe assembly in accordance with the present invention.

FIG. 7 is a close-up view of the syringe assembly during the dispensing phase of the plunger cycle.

FIG. 8 is a close-up view of the syringe assembly during the aspiration phase of the plunger cycle.

FIG. 9 is a plan view of an alternative wiper having a slot.

FIG. 10 is a side view of an alternative wiper having a diagonal slot.

FIG. 11 is a side view of an alternative wiper having a helical slot.

FIG. 12 is a plan view of an alternative wiper having axial groves along the inner radius of the wiper.

FIG. 13 is a perspective view of an alternative two-piece plunger in accordance with the present invention.

### DETAILED DESCRIPTION OF THE INVENTION

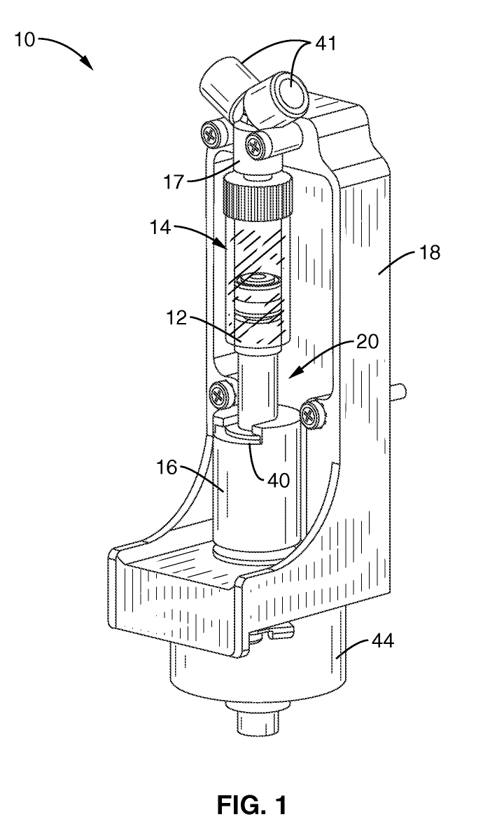

Referring more specifically to the drawings, for illustrative purposes the present invention is embodied in the apparatus generally shown in FIG. 1 through FIG. 13. It will be appreciated that the apparatus may vary as to configuration and as to details of the parts, and that the method may vary as to the specific steps and sequence, without departing from the basic concepts as disclosed herein.

FIG. 1 illustrates a syringe pump assembly 10 having a syringe assembly 14 in accordance with the present invention. Syringe assembly 14 generally comprises a plunger 20 that reciprocates axially within cylindrical barrel 22. The syringe assembly 14 is configured to be interchangeably received within pump housing 18, with the rear flange 38 of plunger 20 disposed within slot 40 of pump arm 16, and the nozzle 24 of barrel 22 in fluid communication with valve 17.

The pump arm 16 reciprocates axially (up and down in FIG. 1) with respect to the pump housing 18 via motion control motor 44 disposed on the bottom of the housing 18. The motor 44 provides a controlled radial motion that is converted to linear motion of the reciprocating pump arm 16 via a worm drive, screw drive, or the like (not shown).

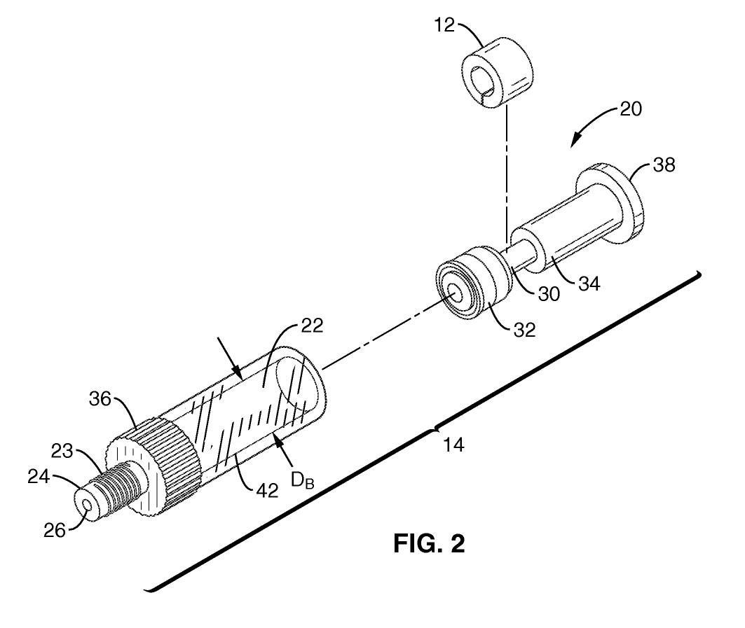

As the plunger 20 reciprocates upward in barrel 22, fluid in the barrel is dispensed out of the barrel via orifice 26 (see FIG. 2) and into valve 17. As the plunger seal 32 moves upward, the wiper 12 engages the inner wall 42 of barrel 22 to lubricate and wipe any debris from the wall surface. The fluid is then directed out one of the Y-shaped ports 41. When the seal 32 reaches the end of its stroke into barrel 22, all the fluid is dispensed from the barrel.

The barrel 22 is then refilled by reciprocating the pump arm 16 and plunger 20 downward in barrel 22 to draw fluid into the other of the y-shaped ports 41. The plunger 20 reciprocates downward to the bottom of its stroke to fill up the barrel 22 with fluid, wherein the cycle may then be repeated again.

FIG. 2 illustrates an exploded view of the syringe assembly 14. The wiper 12 is generally mounted on a step-reduced elongated neck 30 that is disposed between the plunger seal 32 and arm 34. The neck 30 generally has a smaller diameter (see also FIG. 6) than the plunger arm 34 and seal 32 to keep the wiper 12 disposed near the seal 32 as the plunger 20 reciprocates in the barrel 22.

The seal 32 generally comprises a compliant polymer construction that has an outer diameter that is slightly larger than the barrel inner wall 42 diameter Db to create an interference fit with the inner wall of the barrel. The seal 32 slideably engages and bears against the inner bore wall 42 of the barrel 22, providing for a variable volume pump chamber 48, and separation between the liquid filled pump chamber 48 and the dry section of the barrel 22. The barrel chamber 48 volume is established by the bore 42 of the barrel 22 and the barrel segment length between the distal tip of the seal 32 and the entrance to the valve 17. Because fluid invariably leaks from the seal and out chamber 48, crystals and other debris often form on the dry section of the inner barrel wall 42 as the plunger reciprocates to the top of its stroke.

Barrel 22 has a knurled cap 36 with nozzle 24 that has male threads configured to screw into and mate with valve 17. With the barrel 22 secured into the valve 17, it remains fixed as the plunger 20 reciprocates inside the barrel chamber 48.

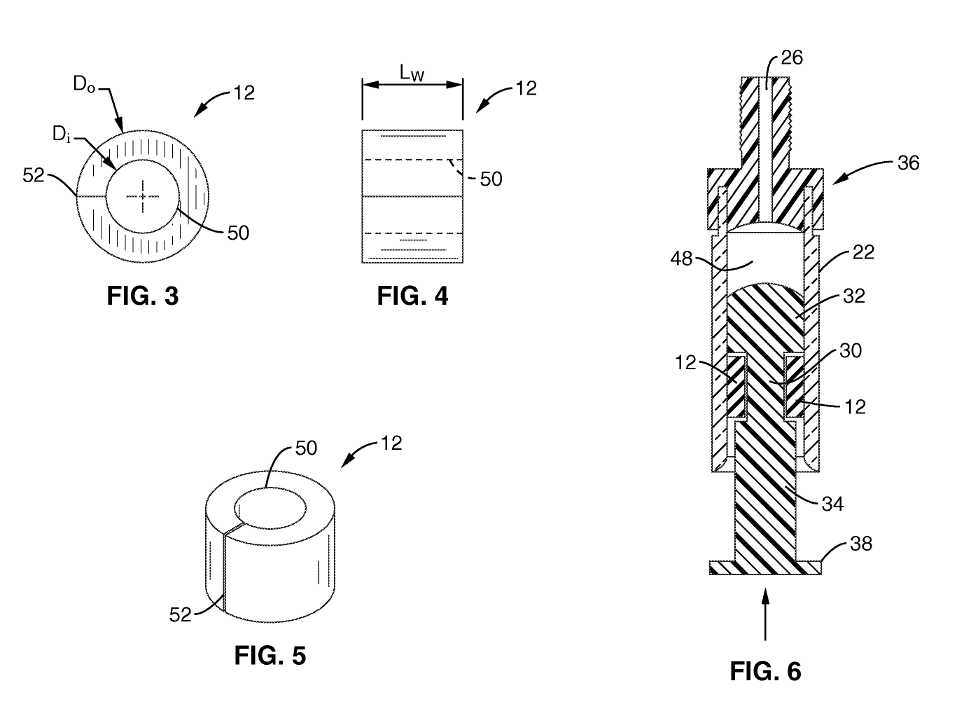

Referring to FIGS. 3-5, the wiper comprises a generally cylindrical tubular member having a central channel or bore that is open at both ends. In a preferred embodiment, the wiper 12 is circumferentially discontinuous at slit 52, which runs axially down one wall of the wiper 12. Slit 52 allows the wiper 12, which is generally comprised of a compliant material, to be spread apart to be installed onto the neck 30 of the plunger 20. The wiper 12 has an inner diameter Dᵢ and outer diameter Dₒ that vary according to the size of the barrel inner wall 42 and neck 30.

The wiper 12 generally comprises a porous polymer that is permeated or impregnated with a lubricant (e.g. silicone oil, fluorinated oil, or the like). The wiper may comprise a number of polymer or like materials (e.g. polyethylene, polypropylene, Teflon, etc.), but is preferably porous so that it can retain a volume of lubricant that is dispensed on to the inner wall over time. In a preferred embodiment, the wiper comprises a porous, ultra-high molecular weight polyethylene.

FIG. 6 illustrates a cross-sectional view of syringe assembly 14, with the plunger disposed inside barrel 22 to define barrel chamber 48. The outer diameter Dₒ of the wiper 12 is sized to be slightly larger than the inner diameter D_{B} of the barrel wall 42 to create an interference fit with the wall 42 along the circumference of the inner wall surface.

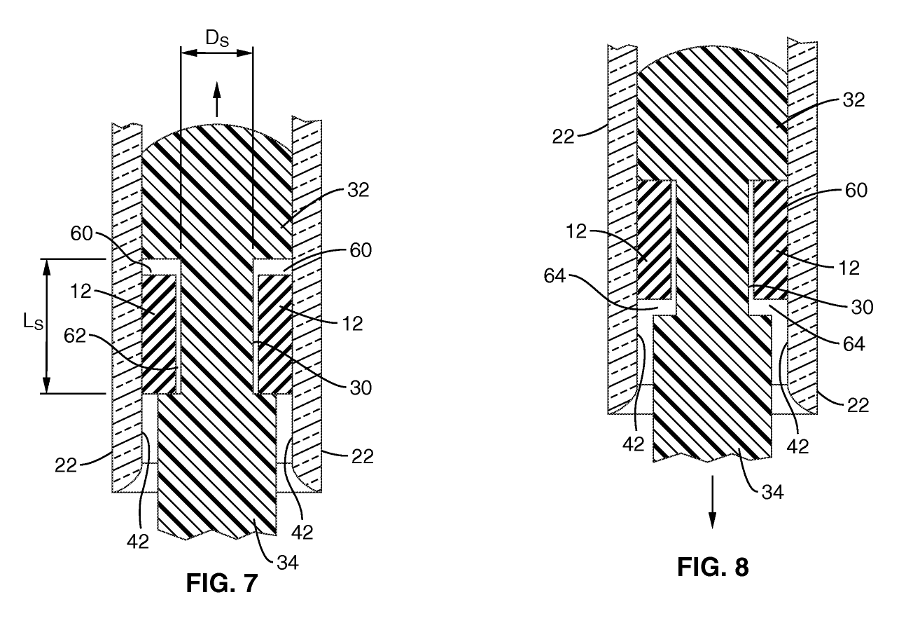

In a preferred embodiment, the inner diameter Dᵢ of the wiper 12 is larger than the diameter Dₛ of the shoulder or neck 30 of the plunger 20 such that a recess 62 (see FIGS. 7 and 8) is created between the wiper 12 and the neck 30 when the wiper 12 is installed on the plunger 20. Recess 62 generally serves two purposes: first, it allows compression of the wiper material into the barrel 22 to create a snug fit with the inner wall 42 without creating too much resistance; and second, it creates a pathway for debris egress, as will be described in further detail below.

As shown in FIG. 6, and further detail in close up views of FIGS. 7 and 8, the wiper 12 has a length L_{w} that is smaller than the length Lₛ of the neck 30. Thus, when the plunger is advancing upward (FIG. 7) in barrel 22 to dispense fluid from chamber 48, the wiper 12 will follow the seal 32 of the plunger upward along the inner wall 42 to lubricate wall 42.

Because the wiper 12 has a snug fit with the inner barrel surface 42, it will initially not translate with the plunger at the first part of the upward stroke. The inner diameter Dᵢ is configured to be smaller than the diameter of the plunger arm 34 such that the proximal end of the wiper will abut against the shoulder of the plunger arm 34 as the plunger arm 34 travels upward. At this point in the stroke, the arm 34 will carry the wiper 12 at a constant distance away from the plunger seal 32 (i.e. reciprocate axially in unison with the plunger arm 34 and seal 32) up the chamber until the distal end of seal 32 contacts the upper extremity of the chamber 48 at the top of the stroke. While traveling, the lubricant impregnated wiper 12 coats the inner surface 42 of the barrel 22 with a controlled, thin layer of lubricant. This layer of lubricant is then in place for the seal 32 lip to form a proper contact and seal with the barrel wall 42 on the down stroke of the plunger (while refilling/aspirating the chamber 48 with fluid).

As seen in FIG. 7, a gap 60 is formed between the end of shorter wiper 12 and the proximal end of the seal 32 into the elongated, step-reduced neck 30 while the plunger arm 34 is reciprocating upward in the barrel 22. This gap 60 facilitates migration of debris that has been deposited on the barrel wall 42 to be scraped off the wall 42 into gap or clearance 60 and migrate downward through annular clearance or recess 62 and toward the proximal end of the plunger 20. It is also appreciated that the inner radius of the wiper 12 may be chamfered (not shown) at the top or distal end to provide a downward slope into and down annular clearance or gap 62 to further promote transfer of debris from the inner wall 42.

FIG. 8 illustrates reciprocation of the plunger 20 axially downward to refill or aspirate the chamber 48. During this part of the stroke, the plunger translates downward until the top or distal end of wiper 12 contacts with, and is carried downward by, the distal shoulder of seal 32. This creates a recess or gap 64 between the bottom or distal end of the wiper 12 and the shoulder of the plunger arm 34. The recess 64 allows egress of debris migrating down annular recess 62 out of the barrel 22. While the wiper reciprocates down the barrel 22, it further coats the inner wall 42 with a thin layer of lubricant to promote proper contact and sliding engagement of the seal 32 with the wall 42.

Thus, the wiping and coating action of the wiper 12 maintains a clean and lubricated inner wall 42 while fluid is being dispensed and aspirated from the chamber, and inhibits debris from building up and adhering to the surface of the inner wall 42. This serves to inhibit increased friction, debris buildup, and seal wear to increase the life of the seal 32.

FIG. 9 illustrates a plan view of an alternative embodiment wiper where slit 52 is widened to form a slot having a thickness T while the wiper 12 is in an uncompressed state. In this configuration, the slot 52 provides additional clearance for the wiper to be compressed (interference fit) into the barrel 22, without creating too much friction. Under the installed compression, the slot 52 may be narrowed or closed up altogether.

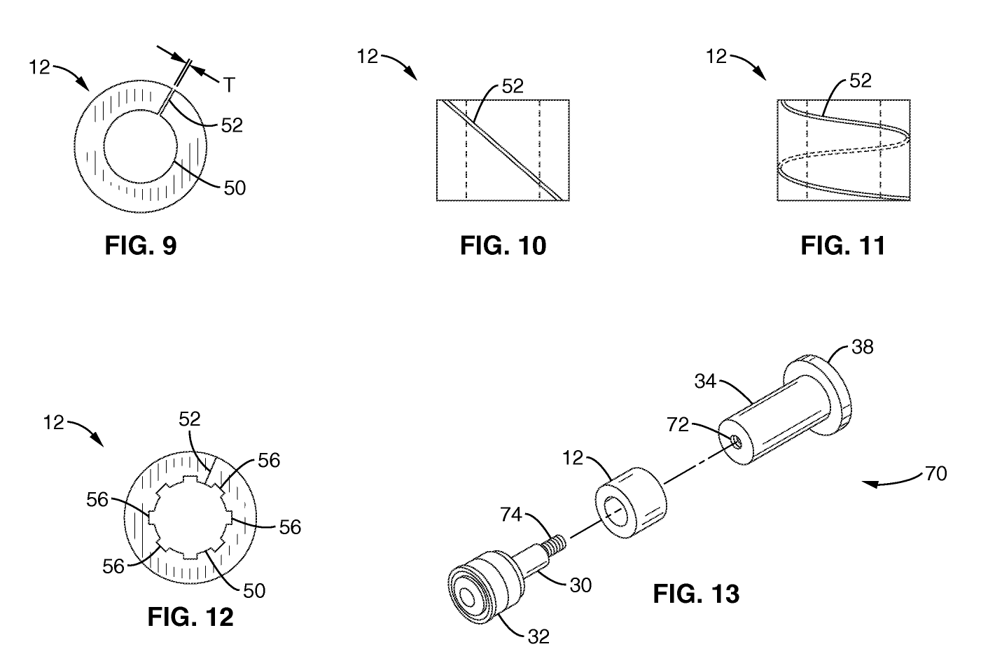

As shown in FIG. 10, the slot 52 of the wiper 12 shown in FIG. 9 may be slanted in a diagonal down the length of the wiper. Alternatively, the slot 52 may spiral down the length of the wiper 12 as shown in FIG. 11. The above configurations ensure that the entire inner barrel bore 42 is wiped and lubricated as the plunger 20 reciprocates in the barrel 22.

FIG. 12 illustrates an alternative embodiment wiper 12 having channels 56 running axially down inner diameter 50 of the wiper. The axial channels 56 further promote migration of debris down the neck 30 of plunger 20 and out of the barrel 22. The slots 56 may be used in cooperation with the annular recess 62, or may be used in an embodiment where no annular recess is present and the inner diameter Dᵢ of the wiper 12 forms a contact fit with the neck 30 of the plunger 20.

FIG. 13 illustrates an alternative embodiment plunger 70 comprising two separable pieces so that wiper 12 may be installed onto the step-reduced neck in an uninterrupted (e.g. circumferentially continuous without slot or slit 52) configuration. In this embodiment, the proximal end of the neck 30 has a male-threaded section 74 that is configured to thread into female threaded recess 72 in the distal end of plunger arm 34.

It is appreciated that the wiper and plunger of the present invention are not limited to the above-illustrated shapes, sizes and configurations. For example, the neck 30 shown above may be rectangular, with the wiper 12 having a corresponding rectangular shaped inner surface 50. The dimensions of the annular clearance 62 and gaps 60 and 64 may also vary based on desired pump volume, material selection, or properties of the liquid/agent that is being dispensed.

Although the embodiments disclosed above are shown with installation in a syringe pump (e.g. reagent pump or the like), it is contemplated that the plunger and wiper assembly may be used in any fluid-dispensing apparatus to extend the life of the plunger and seal, e.g. for lithography, etc.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A syringe for dispensing fluids, comprising:
a cylindrical barrel having a distal end and a proximal end;
the barrel having a chamber emanating at an opening at the proximal end and terminating near the distal end;
a plunger configured to reciprocate axially inside the chamber;
the plunger comprising a distal end having a seal, and a proximal end comprising an arm terminating at a location outside the chamber;
wherein the seal is configured to slideably engage an inside wall of the chamber; and
a wiper disposed on the plunger proximal to the seal;
wherein the wiper holds a volume of lubricant;
wherein the wiper is sized to engage the inner surface of the chamber so that the lubricant is disposed on the inner surface as the plunger reciprocates in the chamber.

2. A syringe as recited in claim 1, wherein the wiper comprises a porous polymer permeated with the volume of lubricant.

3. A syringe as recited in claim 1, wherein the wiper has a cylindrical outer surface that forms an interference fit with the inner surface of the chamber when installed in the chamber.

4. A syringe as recited in claim 3:
wherein the wiper is slideably disposed on the plunger so that a gap is formed between the distal end of the wiper and the proximal end of the seal as the plunger travels distally in the chamber; and
wherein the gap is configured to collect debris from the inner surface of the chamber.

5. A syringe as recited in claim 4:
wherein the wiper has a central channel configured to be disposed over a step-reduced section of the plunger;
the step-reduced section extending a specified length between the proximal end of the seal and the arm of the plunger;
wherein a recess is formed between the wiper and the step-reduced section; and
wherein the recess facilitates migration of the debris proximally along said plunger.

6. A syringe as recited in claim 5:
wherein the length of the step-reduced section is longer than the length of the wiper so that distal reciprocation of the plunger in the chamber causes the wiper to slide axially to the plunger arm at the proximal end of the step-reduced section to form the gap at the distal end;
said gap being in fluid communication with said recess.

7. A syringe as recited in claim 6, wherein proximal reciprocation of the plunger in the chamber causes the wiper to slide axially to the seal at the distal end of the step-reduced section to form a gap between the proximal end of the wiper and the plunger arm to facilitate egress of the collected debris out of the chamber.

8. A syringe as recited in claim 7, wherein the wiper is tubular having an inner diameter defined the central channel; and
wherein the step reduced section comprises a diameter that is smaller than the inner diameter of the wiper to create said recess.

9. A syringe as recited in claim 5, wherein the wiper has a slit running axially down the length of the wiper;
wherein the slit allows the wiper to be installed on the step-reduced section.

10. A syringe assembly for dispensing fluids, comprising:
a cylindrical barrel having a distal end and a proximal end;
the barrel having a chamber emanating at an opening at the proximal end and terminating near the distal end;
a plunger configured to reciprocate axially inside the chamber, comprising:
a distal end having a seal configured to slideably engage an inside wall of the chamber;
a proximal end comprising an arm extending to a location outside the chamber; and
a neck disposed between the seal and the arm;
the neck having a smaller cross-section than the arm and the seal; and
a wiper disposed on the plunger proximal to the seal;
wherein the wiper is disposed over the neck via a central channel in the wiper;
wherein the central channel of the wiper is shaped to form a recess between the wiper and the neck said recess running axially along the length of the wiper;
wherein the wiper has an outer diameter configured to engage the inner wall of the chamber to scrape debris from the wall;
wherein the recess allows migration of the debris to a location outside the chamber.

11. A syringe assembly as recited in claim 10:
wherein the wiper is configured to retain a volume of lubricant; and
wherein the wiper distributes the lubricant to coat the inner wall of the chamber with the lubricant as the plunger reciprocates in said chamber.

12. A syringe assembly as recited in claim 11, wherein the wiper comprises a porous polymer that is permeated with the volume of lubricant and distributes the lubricant from contact with the inner wall of the chamber.

13. A syringe assembly as recited in claim 10:
wherein the wiper has a length that is smaller than the length of the neck;
wherein the wiper is slideably disposed on the neck of the plunger such that, the proximal end of the wiper abuts against the arm of the plunger when the plunger is travelling toward the distal end of the chamber; and
wherein a gap is formed between the distal end of the wiper and the seal, the gap allowing fluid communication from the inner wall of the chamber to the recess between the wiper and the neck.

14. A syringe assembly as recited in claim 13:
wherein the distal end of the wiper abuts against the seal when the plunger is travelling toward the proximal end of the chamber to form a gap between the proximal end of the wiper and the arm;
wherein the gap between the proximal end of the wiper and the arm allows debris egress from the recess to a location external to the chamber.

15. A syringe assembly as recited in claim 10, wherein the central channel of the wiper has a diameter that is larger than the diameter of the neck to form an annular recess between the wiper and the neck.

16. A syringe assembly as recited in claim 10, wherein the central channel of the wiper comprises a groove to facilitate migration of debris proximally out said chamber.

17. A syringe pump assembly, comprising:
a cylindrical barrel having a distal end and a proximal end;
the barrel having a chamber emanating at an opening at the proximal end and terminating near the distal end;
a valve in fluid communication with the distal end of the chamber;
a plunger configured to reciprocate axially inside the chamber, comprising:
a distal end having a seal configured to slideably engage an inside wall of the chamber;
a proximal end comprising an arm extending to a location outside the chamber;
a neck disposed between the seal and the arm;
the neck having a smaller cross-section than the arm and the seal; and
a wiper disposed on the plunger proximal to the seal;
wherein the wiper is disposed over the neck via a central channel in the wiper; and
a reciprocating arm coupled to the proximal end of the plunger arm, the reciprocating arm coupled to a motor for driving motion of the plunger inside the chamber;
wherein the wiper holds a volume of lubricant;
wherein the wiper is sized to engage the inner surface of the chamber so that the lubricant is disposed on the inner surface as the plunger reciprocates in the chamber.

18. A syringe pump assembly as recited in claim 17, wherein the wiper comprises a porous polymer permeated with the volume of lubricant and has a cylindrical outer surface that forms an interference fit with the inner surface of the chamber when installed in the chamber to dispense a layer of lubricant on the inner surface.

19. A syringe pump assembly as recited in claim 18:
wherein the wiper has a length that is smaller than the length of the neck;
wherein the wiper is slideably disposed on the neck of the plunger such that, the proximal end of the wiper abuts against the arm of the plunger when the plunger is travelling toward the distal end of the chamber to dispense fluid out of said chamber and through said valve; and
wherein a gap is formed between the distal end of the wiper and the seal, the gap allowing fluid communication from the inner wall of the chamber to the recess between the wiper and the neck.

20. A syringe pump assembly as recited in claim 19:
wherein the distal end of the wiper abuts against the seal when the plunger is travelling toward the proximal end of the chamber to aspirate fluid through the valve into the chamber;
the wiper forming a gap between the proximal end of the wiper and the arm to allows debris egress from the recess to a location external to the chamber.

21. A syringe pump assembly as recited in claim 20, wherein the central channel of the wiper has a diameter that is larger than the diameter of the neck to form an annular recess between the wiper and the neck.

22. A syringe pump assembly as recited in claim 18, wherein the wiper has a slit running axially down the length of the wiper;
wherein the slit allows the wiper to be installed on the neck.

23. A syringe pump assembly as recited in claim 18, wherein the plunger is separable to install the wiper on to the neck.
